(19) United States
(12) Patent Application Publication
(10) Pub. No.: US 2026/0275793 A1
(43) Pub. Date: Sep. 17, 2026

(54) GETTING-OUT ASSISTANCE APPARATUS

(71) Applicant: TOYOTA JIDOSHA KABUSHIKI KAISHA, Toyota-shi (JP)

(72) Inventors: Hiroaki IIDA, Hashima-shi (JP); Masaho ISHIDA, Toyota-shi (JP); Issei MATSUNAGA, Owariasahi-shi (JP); Haruki HIRASAWA, Nagoya-shi (JP)

(73) Assignee: TOYOTA JIDOSHA KABUSHIKI KAISHA, Toyota-shi (JP)

(21) Appl. No.: 19/454,876

(22) Filed: Jan. 21, 2026

(30) Foreign Application Priority Data
Mar. 13, 2025 (JP) 2025-039992

(51) Int. Cl. E05F 15/40

(52) U.S. Cl. CPC E05F 15/40; E05Y 2400/54; E05Y 2900/531

(57) ABSTRACT

A getting-out assistance apparatus performs a moving object warning for informing an occupant of a host vehicle that there exists a moving object that may come into contact with a door panel opened laterally outward from the host vehicle. The apparatus does not perform the moving object warning when an obstacle exists between a predicted movement path and the door panel in a lateral direction of the host vehicle in a case where the predicted movement path passes through a predetermined lateral region. The predicted movement path is a path predicted as a path on which the moving object moves. The predetermined lateral region is a region within a predetermined distance laterally outward from a side wall of the host vehicle.

### CROSS-REFERENCE TO RELATED APPLICATIONS

This application claims priority to Japanese patent application No. JP 2025-039992 filed on Mar. 13, 2025, the content of which is hereby incorporated by reference in its entirety.

### BACKGROUND

### Field

The present invention relates to a getting-out assistance apparatus.

### Description of the Related Art

There is known a getting-out assistance apparatus which performs a moving object warning for informing an occupant of a host vehicle that there exists a moving object that may come into contact with a door panel opened laterally outward from the host vehicle (for example, see Japanese Patent Laid-Open No. 2022-048511).

There are situations in which an obstacle such as a wire mesh exists beside the host vehicle, and a moving object passes on a far side of the obstacle as viewed from the host vehicle. In such situations, when the moving object warning is performed, it makes the occupant of the host vehicle feel troublesome. Therefore, execution of the moving object warning in such situations is unnecessary.

### SUMMARY

An object of the present invention is to provide a getting-out assistance apparatus capable of preventing unnecessary execution of the moving object warning.

A getting-out assistance apparatus according to the present invention comprises an electronic control unit that performs a moving object warning for informing an occupant of a host vehicle that there exists a moving object that may come into contact with a door panel opened laterally outward from the host vehicle. The electronic control unit is configured to not perform the moving object warning when an obstacle exists between a predicted movement path and the door panel in a lateral direction of the host vehicle in a case where the predicted movement path passes through a predetermined lateral region. The predicted movement path is a path predicted as a path on which the moving object moves. The predetermined lateral region is a region within a predetermined distance laterally outward from a side wall of the host vehicle.

According to the present invention, even when the predicted movement path passes through the predetermined lateral region, when the obstacle exists between the predicted movement path and the door panel in the lateral direction of the host vehicle, the moving object warning is not performed. That is, in a situation in which the moving object passes on a far side of the obstacle relative to the host vehicle, the moving object warning is not performed. Therefore, it is possible to prevent unnecessary execution of the moving object warning.

In the getting-out assistance apparatus according to an aspect of the present invention, the host vehicle may be provided with a surrounding object detection sensor that detects surrounding objects existing around the host vehicle. In this aspect, the electronic control unit may be configured to detect the obstacle by the surrounding object detection sensor.

According to this aspect of the present invention, the obstacle can be detected by using the surrounding object detection sensor mounted on the host vehicle.

Further, in the getting-out assistance apparatus according to another aspect of the present invention, the surrounding object detection sensor may be an image sensor.

For example, when the obstacle is a wire mesh, there is a possibility that the obstacle cannot be detected by an electromagnetic wave sensor such as a radar. According to this aspect of the present invention, the obstacle is detected by using the image sensor. Therefore, the obstacle can be detected more reliably.

Further, in the getting-out assistance apparatus according to further another aspect of the present invention, the door panel may be configured to pivot open relative to the host vehicle. In this aspect, the predetermined distance may be set to be greater than a distance by which the opened door panel protrudes laterally outward from the host vehicle by a maximum amount.

According to this aspect of the present invention, contact of the moving object with the door panel can be prevented more reliably.

Elements of the present invention are not limited to elements of embodiments and modified examples of the present invention described with reference to the drawings. The other objects, features and accompanied advantages of the present invention can be easily understood from the embodiments and the modified examples of the present invention.

### BRIEF DESCRIPTION OF THE DRAWINGS

FIG. 1 is a diagram showing a getting-out assistance apparatus according to an embodiment of the present invention.

FIG. 2 is a diagram showing a host vehicle.

FIG. 3 is a flowchart showing a routine executed by the getting-out assistance apparatus according to the embodiment of the present invention.

FIG. 4 is a diagram showing a situation in which a predicted movement path passes through a predetermined lateral region.

FIG. 5 is a diagram showing the predetermined lateral region.

FIG. 6 is a diagram showing a situation in which an obstacle exists.

### DETAILED DESCRIPTION

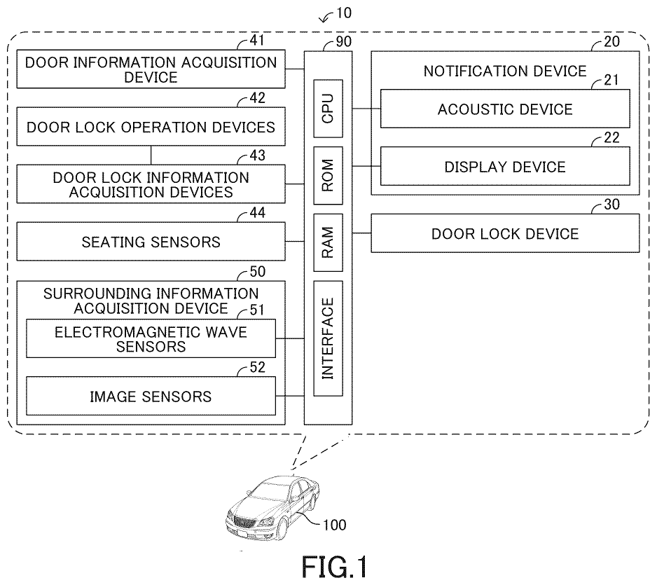

Hereinafter, a getting-out assistance apparatus 10 according to an embodiment of the present invention will be described with reference to the drawings. The getting-out assistance apparatus 10 according to the embodiment of the present invention is shown in FIG. 1. The getting-out assistance apparatus 10 is mounted on a host vehicle 100.

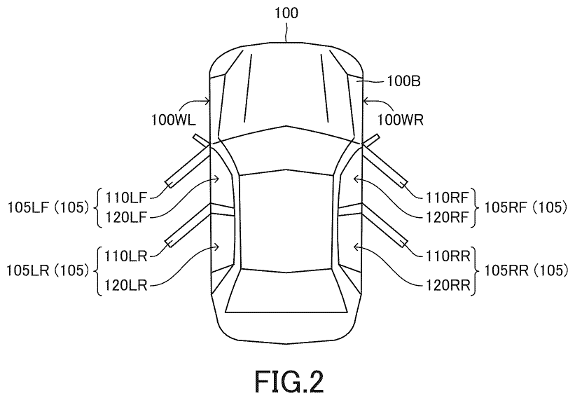

As shown in FIG. 2, the host vehicle 100 includes four doors 105. These doors 105 are a right front door 105RF, a right rear door 105RR, a left front door 105LF, and a left rear door 105LR.

The right front door 105RF is the door 105 provided on a right front side of the host vehicle 100. The right front door 105RF includes a right front door panel 110RF and a right front entrance 120RF. The right rear door 105RR is the door 105 provided on a right rear side of the host vehicle 100. The right rear door 105RR includes a right rear door panel 110RR and a right rear entrance 120RR.

The left front door 105LF is the door 105 provided on a left front side of the host vehicle 100. The left front door 105LF includes a left front door panel 110LF and a left front entrance 120LF. The left rear door 105LR is the door 105 provided on a left rear side of the host vehicle 100. The left rear door 105LR includes a left rear door panel 110LR and a left rear entrance 120LR.

In the following description, the right front door 105RF and the right rear door 105RR are each referred to as a “right-side door 105R”. Further, the left front door 105LF and the left rear door 105LR are each referred to as a “left-side door 105L”. Furthermore, the right front door panel 110RF, the right rear door panel 110RR, the left front door panel 110LF, and the left rear door panel 110LR are each referred to as a “door panel 110”. Furthermore, the right front entrance 120RF, the right rear entrance 120RR, the left front entrance 120LF, and the left rear entrance 120LR are each referred to as an “entrance 120”.

In this example, each door 105 is a swing-type (that is, a pivoting-type) door. Therefore, the door panel 110 of each door 105 is configured to pivot open relative to the host vehicle 100. Therefore, the door panel 110 of each door 105 is attached to a vehicle body 100B of the host vehicle 100 so as to be swingable (that is, pivotable) about a pivot axis line extending vertically at a front portion thereof.

An occupant of the host vehicle 100 can open the door panel 110 in a closed state by pivoting the door panel 110 outward (that is, in a direction away from the vehicle body 100B) about the pivot axis line. On the other hand, the occupant of the host vehicle 100 can close the door panel 110 in an opened state by pivoting the door panel 110 inward (that is, in a direction approaching the vehicle body 100B) about the pivot axis line.

It should be noted that one or more of the doors 105 may be a slide-type (that is, a sliding-type) door. For example, when the right rear door 105RR is a slide-type door, the right rear door panel 110RR is attached to the vehicle body 100B so as to be slidable (that is, slidingly movable) in a longitudinal direction Dx of the host vehicle 100. The occupant of the host vehicle 100 can open the right rear door panel 110RR in a closed state by sliding it rearward. On the other hand, the occupant of the host vehicle 100 can close the right rear door panel 110RR in an opened state by sliding it forward.

Further, as shown in FIG. 1, the getting-out assistance apparatus 10 includes an ECU (electronic control unit) 90 serving as a control device. The ECU 90 includes a microcomputer as a main component. The microcomputer includes a CPU, a computer-readable storage medium, and an interface. The storage medium includes a ROM, a RAM, and a non-volatile memory. The CPU realizes various functions by executing instructions or programs or routines stored in the storage medium. In particular, in this example, the getting-out assistance apparatus 10 stores, in the storage medium, programs for realizing various controls executed by the getting-out assistance apparatus 10.

It should be noted that, in this example, the getting-out assistance apparatus 10 includes only one ECU 90, but may include a plurality of ECUs. In this case, the functions of the getting-out assistance apparatus 10 described later are shared among the respective ECUs.

Further, the getting-out assistance apparatus 10 may be configured such that the programs stored in the storage medium can be updated (updated) by wireless communication (for example, Internet communication) with external devices.

Further, an operator of the host vehicle 100 may be a driver (that is, a person who rides in the host vehicle 100 and drives the host vehicle 100), or may be a remote operator (that is, a person who does not ride in the host vehicle 100 and drives the host vehicle 100 remotely).

Further, the vehicle on which the getting-out assistance apparatus 10 is mounted may be a vehicle which is driven by manual driving by the operator or may be a vehicle which is driven by automatic driving.

The host vehicle 100 is equipped with a notification device 20, a door lock device 30, a door information acquisition device 41, door lock operation devices 42, door lock information acquisition devices 43, seating sensors 44, and a surrounding information acquisition device 50.

The notification device 20 includes an acoustic device 21 and a display device 22.

The acoustic device 21 outputs various sounds and/or voices. The acoustic device 21 includes, for example, a speaker. The acoustic device 21 is electrically connected to the ECU 90. The getting-out assistance apparatus 10 outputs various sounds and/or voices by the acoustic device 21.

The display device 22 displays various images. The display device 22 includes, for example, a display. The display device 22 is electrically connected to the ECU 90. The getting-out assistance apparatus 10 displays various images by the display device 22.

The door lock device 30 locks each door 105 or unlocks each door 105. More specifically, the door lock device 30 locks each door panel 110 to the vehicle body 100B of the host vehicle 100 or unlocks the lock of each door panel 110. The door lock device 30 is electrically connected to the ECU 90. The getting-out assistance apparatus 10 controls an operation of the door lock device 30.

The door information acquisition device 41 is used to acquire information on whether each door 105 is in an opened state or in a closed state. The door information acquisition device 41 includes, for example, door sensors that acquire information on whether each door 105 is in an opened state or in a closed state. The door sensor is used to acquire a pivot angle θs of the swing-type door panel 110. Alternatively, the door sensor is used to acquire a sliding distance Ls of the slide-type door panel 110. It should be noted that the pivot angle θs is an angle through which the door panel 110 of the door 105 is pivoted from a closed position when the door 105 is a swing-type door. Further, the sliding distance Ls is a distance through which the door panel 110 of the door 105 is slid from a closed position when the door 105 is a slide-type door.

The door information acquisition device 41 is electrically connected to the ECU 90. The getting-out assistance apparatus 10 acquires, as door information ID, information on whether each door 105 is in an opened state or in a closed state by the door information acquisition device 41. In particular, the getting-out assistance apparatus 10 acquires, as the door information ID, the pivot angle θs of the swing-type door panel 110 by the door information acquisition device 41. Alternatively, the getting-out assistance apparatus 10 acquires, as the door information ID, the sliding distance Ls of the slide-type door panel 110 by the door information acquisition device 41.

The door lock operation devices 42 are operated by occupants of the host vehicle 100. The door lock operation devices 42 are, for example, door lock

### Switches Operated by the Occupants of the Host Vehicle 100.

The door lock information acquisition devices 43 are used to detect operations applied to the door lock operation devices 42. The door lock information acquisition devices 43 are, for example, door lock sensors that are used to detect operations applied to the door lock operation devices 42.

The door lock operation devices 42 are electrically connected to the door lock information acquisition devices 43. The door lock information acquisition devices 43 are electrically connected to the ECU 90. The getting-out assistance apparatus 10 acquires information on operations applied to the door lock operation devices 42 by the door lock information acquisition devices 43. The getting-out assistance apparatus 10 locks each door 105 or unlocks the lock thereof by operating the door lock device 30 based on the acquired information. Therefore, the occupants of the host vehicle 100 can lock each door 105 or unlock the lock thereof by the door lock device 30 by operating the door lock operation devices 42.

The seating sensors 44 are sensors that is used to detect occupants seated in seats of the host vehicle 100. The seating sensors 44 are electrically connected to the ECU 90. The getting-out assistance apparatus 10 determines whether or not a person is onboard the host vehicle 100 based on information acquired by the seating sensors 44.

The surrounding information acquisition device 50 is used to acquire information on a situation around the host vehicle 100. In this example, the surrounding information acquisition device 50 includes a plurality of electromagnetic wave sensors 51 and a plurality of image sensors 52.

The electromagnetic wave sensors 51 are electrically connected to the ECU 90. The electromagnetic wave sensors 51 are, for example, radar sensors such as millimeter-wave radars. The getting-out assistance apparatus 10 acquires, as surrounding information IS, information (object information IO) on objects existing around the host vehicle 100 by the electromagnetic wave sensors 51. In particular, the object information IO includes information on moving objects 200.

The moving object 200 is an object that approaches the host vehicle 100. The moving object 200 is, for example, another vehicle, a motorcycle, a bicycle, or a pedestrian.

The image sensors 52 are electrically connected to the ECU 90. The image sensors 52 are, for example, camera sensors. The getting-out assistance apparatus 10 acquires, as surrounding information IS, image information IC on surroundings of the host vehicle 100 by the image sensors 52. In particular, the image information IC includes information on the moving objects 200.

As described above, the electromagnetic wave sensors 51 and the image sensors 52 are surrounding object detection sensors that detect surrounding objects existing around the host vehicle 100.

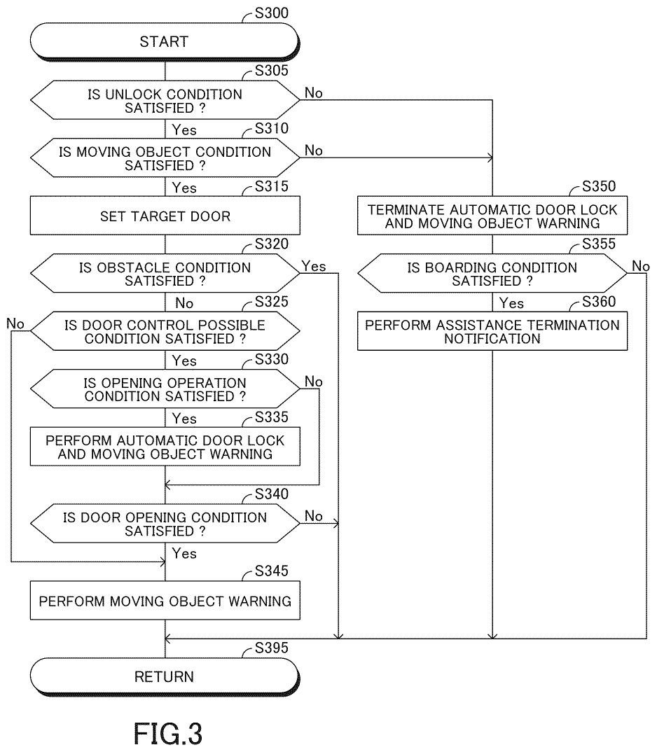

Next, an operation of the getting-out assistance apparatus 10 will be described. The getting-out assistance apparatus 10 is configured to perform a moving object warning as getting-out assistance when predetermined conditions are satisfied by executing a routine shown in FIG. 3.

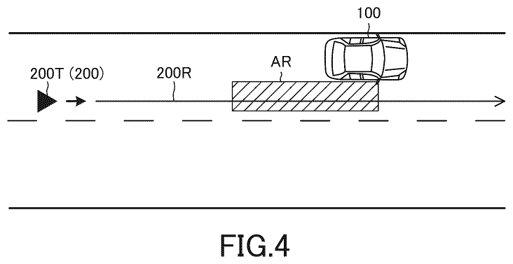

The moving object warning is a warning for informing the occupant of the host vehicle 100 that there exists a moving object 200 that may come into contact with the door panel 110 opened laterally outward from the host vehicle 100 as shown in FIG. 4. This prevents the moving object 200 from coming into contact with the door panel 110 opened for a person to get out of the host vehicle 100. Also, contact of the moving object 200 with a person who has gotten out of the host vehicle 100 is prevented.

When a predetermined timing comes, the getting-out assistance apparatus 10 starts a process from a step S300 of the routine shown in FIG. 3. Then, the getting-out assistance apparatus 10 proceeds with the process to a step S305 to determine whether or not an unlock condition C1 is satisfied.

The unlock condition C1 is satisfied when the lock of the door 105 by the door lock device 30 is unlocked in any one door 105. It should be noted that, when the door panel 110 is in an opened state, the lock of the door panel 110 is unlocked. Therefore, at this time, the unlock condition C1 is also satisfied. The getting-out assistance apparatus 10 determines whether or not the unlock condition C1 is satisfied based on the door information ID.

When the getting-out assistance apparatus 10 determines “Yes” at the step S305, the getting-out assistance apparatus 10 proceeds with the process to a step S310 to determine whether or not a moving object condition C2 is satisfied.

The moving object condition C2 is satisfied when a predicted movement path 200R passes through a predetermined lateral region A. The predicted movement path 200R is a path predicted as a path on which a target moving object 200T moves. The target moving object 200T is a moving object 200 predicted to reach the predetermined lateral region A within a predetermined time Tth. Further, the predetermined lateral region A is a region within a predetermined distance dW laterally outward from a side wall (that is, a right wall surface 100WR or a left wall surface 100WL) of the host vehicle 100.

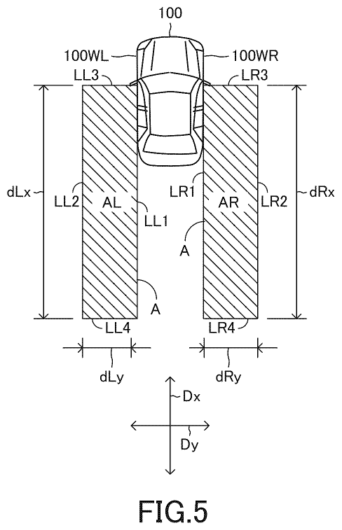

More specifically, as shown in FIG. 5, the predetermined lateral region A includes a predetermined right lateral region AR and a predetermined left lateral region AL. The predetermined right lateral region AR is an area on a right side of the host vehicle 100. The predetermined left lateral region AL is an area on a left side of the host vehicle 100.

The predetermined right lateral region AR is an area defined by a right wall surface longitudinal line LR1, a right-side longitudinal line LR2, a right-front lateral line LR3, and a right-rear lateral line LR4.

The right wall surface longitudinal line LR1 is a line extending in the longitudinal direction Dx of the host vehicle 100 along the right wall surface 100WR of the host vehicle 100. The right-side longitudinal line LR2 is a line extending in the longitudinal direction Dx of the host vehicle 100 in parallel with the right wall surface longitudinal line LR1 and spaced by the predetermined distance dW (that is, a predetermined right-side width dRy) rightward from the right wall surface longitudinal line LR1.

The right-front lateral line LR3 is a line extending in a lateral direction Dy of the host vehicle 100 through a front end portion of the right front door 105RF. The right-rear lateral line LR4 is a line extending in the lateral direction Dy of the host vehicle 100 in parallel with the right-front lateral line LR3 and spaced by a predetermined distance (that is, a predetermined right-side length dRx) rearward from the right-front lateral line LR3.

In this example, the predetermined right-side width dRy is set to a first non-contact length d1 when at least one of the right-side doors 105R is a swing-type door. Here, the first non-contact length d1 is a length in which the moving object 200 does not come into contact with the door panel 110 of the right-side door 105R when its pivot angle θs reaches a maximum angle θmax. Therefore, the predetermined right-side width dRy is set to a distance larger than a distance by which the opened door panel 110 protrudes laterally outward from the host vehicle 100 by a maximum amount.

Also, the predetermined right-side width dRy is set to a second non-contact length d2 when both of the right-side doors 105R are slide-type doors. The second non-contact length d2 is a length in which the moving object 200 does not come into contact with a person immediately after getting off the opened right-side door 105R from the entrance 120.

Further, in this example, the predetermined right-side length dRx is set to a length minimally necessary for a moving object 200, which is moving within the predetermined right lateral region AR toward the door panel 110 of the right-side door 105R in an opened state, to go out of the predetermined right lateral region AR in order to avoid the door panel 110 of the right-side door 105R. Therefore, in this example, the predetermined right-side length dRx is set to a longer length as a moving speed V2 of the moving object 200 becomes higher.

It should be noted that the predetermined right-side length dRx may be set to a length longer than the minimally-necessary length or may be set to a length shorter than the minimally-necessary length. Further, in these cases, the predetermined right-side length dRx is set according to the moving speed V2 of the moving object 200. However, the predetermined right-side length dRx may be set to a constant length.

Further, in this example, one predetermined right lateral region AR is set in common to the right front door 105RF and the right rear door 105RR, but predetermined right lateral regions AR for each of the right front door 105RF and the right rear door 105RR may be set.

The predetermined left lateral region AL is an area defined by a left wall surface longitudinal line LL1, a left-side longitudinal line LL2, a left-front lateral line LL3, and a left-rear lateral line LL4.

The left wall surface longitudinal line LL1 is a line extending in the longitudinal direction Dx of the host vehicle 100 along the left wall surface 100WL of the host vehicle 100. The left-side longitudinal line LL2 is a line extending in the longitudinal direction Dx of the host vehicle 100 in parallel with the left wall surface longitudinal line LL1 and spaced by the predetermined distance dW (that is, a predetermined left-side width dLy) leftward from the left wall surface longitudinal line LL1.

The left-front lateral line LL3 is a line extending in the lateral direction Dy of the host vehicle 100 through a front end portion of the left front door 105LF. The left-rear lateral line LL4 is a line extending in the lateral direction Dy of the host vehicle 100 in parallel with the left-front lateral line LL3 and spaced by a predetermined distance (that is, a predetermined left-side length dLx) rearward from the left-front lateral line LL3.

In this example, the predetermined left-side width dLy is set to the first non-contact length d1 when at least one of the left-side doors 105L is a swing-type door. Here, the first non-contact length d1 is a length in which the moving object 200 does not come into contact with the door panel 110 of the left-side door 105L when its pivot angle θs reaches the maximum angle θmax. Therefore, the predetermined left-side width dLy is set to a distance larger than a distance by which the opened door panel 110 protrudes laterally outward from the host vehicle 100 by a maximum amount.

Further, the predetermined left-side width dLy is set to the second non-contact length d2 when both of the left-side doors 105L are slide-type doors. The second non-contact length d2 is a length in which the moving object 200 does not come into contact with a person immediately after getting off from the entrance 120 of the opened left-side door 105L.

Also, in this example, the predetermined left-side length dLx is set to a length minimally necessary for a moving object 200, which is moving within the predetermined left lateral region AL toward the door panel 110 of the left-side door 105L in an opened state, to go out of the predetermined left lateral region AL in order to avoid the door panel 110 of the left-side door 105L. Therefore, in this example, the predetermined left-side length dLx is set to a longer length as the moving speed V2 of the moving object 200 becomes higher.

It should be noted that the predetermined left-side length dLx may be set to a length longer than the minimally-necessary length or may be set to a length shorter than the minimally-necessary length. Further, in these cases, the predetermined left-side length dLx is set according to the moving speed V2 of the moving object 200. However, the predetermined left-side length dLx may be set to a constant distance.

Further, in this example, the predetermined right-side width dRy and the predetermined left-side width dLy are lengths equal to each other, and the predetermined right-side length dRx and the predetermined left-side length dLx are lengths equal to each other.

Further, in this example, one predetermined left lateral region AL is set in common to both the left front door 105LF and the left rear door 105LR, but predetermined left lateral regions AL for each of the left front door 105LF and the left rear door 105LR may be set.

Further, the getting-out assistance apparatus 10 determines whether or not the moving object condition C2 is satisfied based on the surrounding information IS. More specifically, the getting-out assistance apparatus 10 predicts a path on which the target moving object 200T moves based on the surrounding information IS and acquires the predicted path as the predicted movement path 200R. Then, the getting-out assistance apparatus 10 determines whether or not the predicted movement path 200R passes through the predetermined lateral region A.

When the getting-out assistance apparatus 10 determines “Yes” at the step S310, the getting-out assistance apparatus 10 proceeds with the process to a step S315 to set a target door 105T. The target door 105T is the door 105 corresponding to the predetermined lateral region A through which the predicted movement path 200R passes at the step S310.

Next, the getting-out assistance apparatus 10 proceeds with the process to a step S320 to determine whether or not an obstacle condition C3 is satisfied.

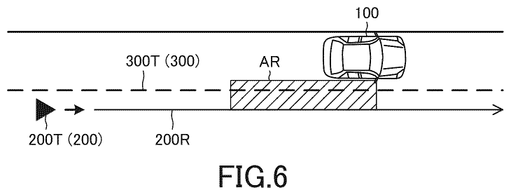

The obstacle condition C3 is satisfied when a target obstacle 300T exists as shown in FIG. 6. The target obstacle 300T is an obstacle 300 which exists in the predetermined lateral region A corresponding to the target door 105T and exists between the target door 105T and the predicted movement path 200R.

In other words, the obstacle condition C3 is satisfied when the obstacle 300 exists between the predicted movement path 200R and the door panel 110 of the target door 105T in the lateral direction of the host vehicle 100.

It should be noted that, in this example, the obstacle 300 is a wire mesh, curb, rubber pole, mesh fence, wire-rope-type guard fence, or a non-metal obstacle.

The getting-out assistance apparatus 10 determines whether or not the obstacle condition C3 is satisfied based on the surrounding information IS. More specifically, the getting-out assistance apparatus 10 detects the obstacle 300 based on the surrounding information IS and acquires a position of the obstacle 300. That is, the getting-out assistance apparatus 10 detects the obstacle 300 by the surrounding object detection sensors and acquires the position of the obstacle 300. In particular, the getting-out assistance apparatus 10 detects the obstacle 300 based on the image information IC and acquires the position of the obstacle 300. Then, the getting-out assistance apparatus 10 determines whether or not the obstacle 300 exists between the predicted movement path 200R and the door panel 110 of the target door 105T in the lateral direction of the host vehicle 100 based on the predicted movement path 200R and the position of the obstacle 300.

When the getting-out assistance apparatus 10 determines “No” at the step S320, the getting-out assistance apparatus 10 proceeds with the process to a step S325 to determine whether or not a door control possible condition C4 is satisfied.

The door control possible condition C4 is satisfied when the getting-out assistance apparatus 10 has a configuration capable of locking the door 105 autonomously. It should be noted that, in this example, the getting-out assistance apparatus 10 can autonomously lock the door 105 by the door lock device 30. Therefore, in this example, the door control possible condition C4 is always satisfied.

When the getting-out assistance apparatus 10 determines “Yes” at the step S325, the getting-out assistance apparatus 10 proceeds with the process to a step S330 to determine whether or not an opening operation condition C5 is satisfied.

The opening operation condition C5 is satisfied when an occupant of the host vehicle 100 performs an operation to open the target door 105T. On the other hand, the opening operation condition C5 is not satisfied until an occupant of the host vehicle 100 performs an operation to open the target door 105T after the lock of the target door 105T is unlocked. On the other hand, the opening operation condition C5 becomes unsatisfied when the process of this routine is terminated once after an occupant of the host vehicle 100 performs an operation to open the target door 105T. The getting-out assistance apparatus 10 determines whether or not the opening operation condition C5 is satisfied based on the door information ID.

When the getting-out assistance apparatus 10 determines “Yes” at the step S330, the getting-out assistance apparatus 10 proceeds with the process to a step S335 to perform an automatic door lock and a moving object warning.

The automatic door lock is a process in which the getting-out assistance apparatus 10 autonomously locks the target door 105T. The getting-out assistance apparatus 10 performs the automatic door lock by controlling an operation of the door lock device 30.

Further, as described above, the moving object warning is a process of issuing a warning to inform an occupant of the host vehicle 100 that there exists a moving object 200 that may come into contact with the door 105 of the host vehicle 100. The getting-out assistance apparatus 10 performs the moving object warning by outputting a warning sound and/or voice from the acoustic device 21. The getting-out assistance apparatus 10 may perform the moving object warning by displaying a predetermined image by the display device 22. Next, the getting-out assistance apparatus 10 proceeds with the process to a step S340.

On the other hand, when the getting-out assistance apparatus 10 determines “No” at the step S330, the getting-out assistance apparatus 10 proceeds with the process to the step S340 directly. At this time, when the getting-out assistance apparatus 10 has autonomously locked the target door 105T, the getting-out assistance apparatus 10 continues the autonomous locking of the target door 105T. Further, when the getting-out assistance apparatus 10 has performed the moving object warning, the getting-out assistance apparatus 10 continues the moving object warning.

When the getting-out assistance apparatus 10 proceeds with the process to the step S340, the getting-out assistance apparatus 10 determines whether or not a door opening condition C6 is satisfied.

The door opening condition C6 is satisfied when the target door 105T is open. On the other hand, the door opening condition C6 is not satisfied when the target door 105T is closed. The getting-out assistance apparatus 10 determines whether or not the door opening condition C6 is satisfied based on the door information ID.

When the getting-out assistance apparatus 10 determines “No” at the step S340, the getting-out assistance apparatus 10 proceeds with the process to a step S395 directly to terminate the process of this routine once. On the other hand, when the getting-out assistance apparatus 10 determines “Yes” at the step S340, the getting-out assistance apparatus 10 proceeds with the process to a step S345 to perform the moving object warning. The moving object warning here is performed when the target moving object 200T is detected after the door 105 is opened. Next, the getting-out assistance apparatus 10 proceeds with the process to the step S395 to terminate the process of this routine once.

When the getting-out assistance apparatus 10 determines “No” at the step S325, the getting-out assistance apparatus 10 proceeds with the process to the step S345 directly to perform the moving object warning. The moving object warning here is performed when the getting-out assistance apparatus 10 does not have a configuration capable of autonomously locking the door 105. Next, the getting-out assistance apparatus 10 proceeds with the process to the step S395 to terminate the process of this routine once.

When the getting-out assistance apparatus 10 determines “Yes” at the step S320, the getting-out assistance apparatus 10 proceeds with the process to the step S395 to terminate the process of this routine once. In this case, the getting-out assistance apparatus 10 performs neither the automatic door lock nor the moving object warning.

As described above, when the predicted movement path 200R passes through the predetermined lateral region A and the obstacle 300 exists between the predicted movement path 200R and the door panel 110 in the lateral direction of the host vehicle 100, the getting-out assistance apparatus 10 does not perform the moving object warning.

When the getting-out assistance apparatus 10 determines “No” at the step S305, the getting-out assistance apparatus 10 proceeds with the process to a step S350, and at this time, when the automatic door lock and/or the moving object warning has been performed, the getting-out assistance apparatus 10 terminates the automatic door lock and/or the moving object warning.

Also, when the getting-out assistance apparatus 10 determines “No” at the step S310, the getting-out assistance apparatus 10 proceeds with the process to the step S350, and at this time, when the automatic door lock and/or the moving object warning has been performed, the getting-out assistance apparatus 10 terminates the automatic door lock and/or the moving object warning.

It should be noted that, as a condition for terminating the automatic door lock and/or the moving object warning, a condition that a predetermined time has elapsed after an ignition switch of the host vehicle 100 is turned off may be adopted. Alternatively, in addition to or instead of this condition, as a condition for terminating the automatic door lock and/or the moving object warning, a condition that the door lock operation device 42 is operated and the target door 105T is locked after the ignition switch is turned off may be adopted.

Next, the getting-out assistance apparatus 10 proceeds with the process to a step S355 to determine whether or not a boarding condition C7 is satisfied.

The boarding condition C7 is satisfied when an occupant is present in the host vehicle 100. On the other hand, the boarding condition C7 is not satisfied when no occupant is present in the host vehicle 100. The getting-out assistance apparatus 10 determines whether or not the boarding condition C7 is satisfied based on information acquired by the seating sensors 44.

When the getting-out assistance apparatus 10 determines “Yes” at the step S355, the getting-out assistance apparatus 10 proceeds with the process to a step S360 to perform an assistance termination notification. Next, the getting-out assistance apparatus 10 proceeds with the process to the step S395 to terminate the process of this routine once.

The assistance termination notification is a process of issuing a notification to inform a person riding in the host vehicle 100 that the automatic door lock and/or the moving object warning has been terminated. The getting-out assistance apparatus 10 performs the assistance termination notification by outputting a warning sound and/or voice from the acoustic device 21. The getting-out assistance apparatus 10 may perform the assistance termination notification by displaying a predetermined image by the display device 22.

On the other hand, when the getting-out assistance apparatus 10 determines “No” at the step S355, the getting-out assistance apparatus 10 proceeds with the process to the step S395 directly to terminate the process of this routine once. In this case, the getting-out assistance apparatus 10 does not perform the assistance termination notification.

The above is the operation of the getting-out assistance apparatus 10.

According to the getting-out assistance apparatus 10, even when the predicted movement path 200R passes through the predetermined lateral region A, when the obstacle 300 exists between the predicted movement path 200R and the door panel 110 in the lateral direction of the host vehicle 100, the moving object warning is not performed. That is, in a situation in which the moving object 200 passes on a far side of the obstacle 300 relative to the host vehicle 100, the moving object warning is not performed. Therefore, unnecessary execution of the moving object warning can be prevented.

It should be noted that the present invention is not limited to the above embodiment, and various modified examples can be adopted within a scope of the present invention.

For example, the getting-out assistance apparatus 10 may be configured to perform the moving object warning for informing an occupant of the host vehicle 100 that there exists a moving object approaching the host vehicle 100 from a front side which may come into contact with an opened door panel 110. In this case, as the predetermined lateral region A, a region extending forward from the right front door 105RF and the left front door 105LF is set.

What is claimed is:

1. A getting-out assistance apparatus comprising an electronic control unit that performs a moving object warning for informing an occupant of a host vehicle that there exists a moving object that may come into contact with a door panel opened laterally outward from the host vehicle,
wherein the electronic control unit is configured to not perform the moving object warning when an obstacle exists between a predicted movement path and the door panel in a lateral direction of the host vehicle in a case where the predicted movement path passes through a predetermined lateral region,
the predicted movement path is a path predicted as a path on which the moving object moves, and
the predetermined lateral region is a region within a predetermined distance laterally outward from a side wall of the host vehicle.

2. The getting-out assistance apparatus according to claim 1,
wherein the host vehicle is provided with a surrounding object detection sensor that detects surrounding objects existing around the host vehicle, and
the electronic control unit is configured to detect the obstacle by the surrounding object detection sensor.

3. The getting-out assistance apparatus according to claim 2, wherein the surrounding object detection sensor is an image sensor.

4. The getting-out assistance apparatus according to claim 1,
wherein the door panel is configured to pivot open relative to the host vehicle, and
the predetermined distance is set to be greater than a distance by which the opened door panel protrudes laterally outward from the host vehicle by a maximum amount.
